(19) United States
(12) Patent Application Publication
(10) Pub. No.: US 2006/0216211 A1
(43) Pub. Date: Sep. 28, 2006

(54) Sample holder and microscope assembly

(75) Inventors: Urban Liebel, Heidelberg (DE); Rainer Pepperkok, Reilimgen (DE); Siegfried Winkler, Heidelberg (DE); Helmut Schaar, Waibstadt (DE); Wolfgang Dilling, Heidelberg (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: EUROPEAN MOLECULAR BIOLOGY LABORATORY

(21) Appl. No.: 11/396,810

(22) Filed: Apr. 3, 2006

Related U.S. Application Data
(63) Continuation of application No. PCT/DE04/02208, filed on Oct. 4, 2004.

(30) Foreign Application Priority Data
Oct. 2, 2003 (DE) 103 46 517.0

(51) Int. Cl. B01L 3/00

(52) U.S. Cl. 422/102

(57) ABSTRACT

A sample holder for handling samples to be viewed under a microscope, and which comprises a base frame 1 provided with a lower surface 2, an upper surface 3, and at least one receiving area 4 for at least one sample. In order to facilitate examination of a large number of samples, the sample holder is provided with a coupling area 5 on its upper surface for receiving at least one other functional element, such as a sample fixing element, a heating or cooling plate, or a cover.

### CROSS REFERENCE TO RELATED APPLICATION

The present application is a continuation of international application PCT/DE2004/002208, filed 4 Oct., 2004, and which designates the U.S. The disclosure of the referenced application is incorporated herein by reference.

### BACKGROUND OF THE INVENTION

The present invention relates to a sample holder, in particular for handling samples to be viewed under a microscope. The sample holder has a base frame, and the base frame comprises an underside, an upper side, and at least one receiving area for at least one sample. Furthermore, the present invention relates to a microscope assembly with a corresponding sample holder.

Sample holders of the type referred to above are known from practice and exist in a variety of embodiments and sizes. Sample holders of this type are most frequently formed by a frame-like rack into which samples can be inserted. Object holders, chamber cover slips, or so-called chamber slides can serve as samples of this type, which in given cases can receive several different substances in individual chambers. The known sample holders can then be positioned with the underside of the base frame, for example, on a microscope table so that microscopic examination is made possible.

It is frequently necessary, in particular for biological samples, to expose the sample to a heat treatment before or during a microscopic examination. Thereby, for example, bacteria cultures can be incubated at a predefined temperature in order to promote their growth. With regard to this, it is a known practice to install heating elements under a microscope or use warming plates which are placed on the microscope or on the microscope table.

With the known sample holders and heating devices it is problematic that they are ultimately not suitable to ensure high throughput of sample examinations. The known sample holders must be moved and positioned by hand, and during transport from the microscope to, for example, another examining area or in transport to a microscope it is not possible with the conventional heating devices to ensure a predefined temperature of the samples even during the transport. In order to ensure this kind of substantially constant temperature of the samples, even during transport, additional heating and/or insulation devices are commonly used. However, this is quite expensive and reduces high sample throughput in the sample examination.

The objective of the present invention is thus to provide a sample holder and a microscope assembly of the type mentioned above, according to which high sample throughput is possible with means which are simple from the standpoint of construction.

### SUMMARY OF THE INVENTION

The above and other objects and advantages of the invention are achieved by the provision of a sample holder of the above described type and which is developed and extended in such a manner that the base frame comprises on its upper surface a coupling area for at least one additional functional element.

In a manner according to the invention it has been recognized that a special development of the base frame on its upper surface realizes the above objective in a surprisingly simple manner. For this, the base frame comprises on its upper surface in concrete terms a coupling area for at least one additional functional element. Thereby, it is made possible to expose the sample or samples to desired treatment measures in a simple manner. These could, for example, be a warming treatment or a cooling treatment, where then at least one heating and/or cooling device is to be coupled with the base frame at its coupling area. This permits the development of a sample holder as a functional unit to provide desired additional functions which can be exercised along with the basic function of the sample holder, namely the handling of samples. For example, a simple transportable and handleable incubation unit for a microscope could be formed.

The sample holder according to the invention can be used in a variety of ways and makes possible, e.g., with the use of a heat in a device as an additional functional element, a reliable warming treatment even during transport of the sample holder from one microscope assembly to, for example, another examination area. Through this simplification of handling, a higher sample throughput of samples to be examined is realized. Consequently, with the sample holder according to the invention a sample holder is specified in which high sample throughput is made possible with means which are simple from the standpoint of construction.

With regard to a particularly stable embodiment of the sample holder and to provide a correspondingly stable coupling area, the base frame could comprise side walls which are connected to one another. In this case the upper surface of the base frame is formed by the upper ends of the side walls, in whose area the coupling area can be formed. In concrete terms, the coupling area can be formed by a recess, groove, or channel running on the upper surface of the side walls, with which recess, groove, or channel a functional element for secure coupling to the sample holder can engage.

With regard to high sample throughput, an adapter can be disposed in the base frame to form individual receiving areas. The adapter could then be formed in such a manner that it also comprises several compartments essentially separated from one another which serve as separate receiving areas for samples. With this, several samples can be handled simultaneously by means of the sample holder. In concrete terms, the adapter could be set in a container-like receiving area, which is formed by the base frame and the side walls of the sample holder which connect to the base frame. Along with this, the adapter could comprise a closed frame with cross pieces extending between the frame legs. Therewith, separate receiving areas are provided between the frame legs.

With regard to particularly reliable handling, in particular of several samples, a preferably frame-like fixing element for the sample or samples can be set on or in the base frame. The fixing element could press the sample or samples against the base frame and/or an adapter and/or corresponding receiving areas so that a secure arrangement of the sample or the samples in the sample holder is ensured. Thereby, a particularly secure transport of samples disposed in the sample holder is made possible. The fixing element could be set on the side walls of the sample holder, where here the coupling area of the base frame could be used. Thereby, the fixing element forms an additional functional element.

With regard to a particularly secure fixing of the sample or samples in the sample holder, the fixing element could comprise at least one spring to press the sample or samples onto the base frame or onto the adapter. In this case a three-part assembly consisting of the base frame, adapter, and fixing element could be produced in a particularly advantageous manner, where the fixing element could press the sample or samples against the adapter. There the adapter could in turn be pressed against the base frame. To that extent the fixing element could provide a secure overall assembly consisting of the base frame, adapter, and fixing element. To ensure a secure overall assembly at least of the fixing element and base frame the fixing element could be latched or clamped to the base frame. The adapter could then be disposed between the fixing element and base frame.

For a more secure clamping of the fixing element onto the base frame the base frame could comprise at least one clamp which engages around the fixing element at a suitable position. A clamp of this type could be preloaded with a spring in order to prevent an undesired loosening of the fixing element from the base frame.

To realize a sandwich system of sample holders and additional functional elements the fixing element could also comprise a coupling area for at least one additional functional element. Thereby, a secure assembly of sample holder, fixing element, and an additional functional element can be realized. In this case there could be an arrangement of the components one over another. For example, a warming plate or cooling plate could be mounted on the fixing element.

In particular with regard to automated handling of the sample holder by means, for example, of a robot, the base frame could comprise grip areas. The grip areas could preferably be roughened in order, for example, to enable gripping of the sample holder by means of a needle gripper.

With regard to reliable temperature control of the sample holder and the sample disposed therein the base frame could comprise recesses and/or passages to limit heat transfers and heat-conducting processes. With regard to this, the base frame could comprise on its underside support points which are raised or project out from the underside. Thereby a significant reduction of heat transfer to the base on which the sample holder can be disposed is realized.

In regard to multiple use of the sample holder under particularly hygienic conditions the base frame and/or the adapter and/or the fixing element could be autoclaved. Thereby, a particularly thorough cleaning is ensured. In this case the base frame and/or the adapter and/or the fixing element can be formed of metal.

For space-saving and secure storage of the sample holder the base frame and/or the adapter and/or the fixing element could be stackable. For this, these components could comprise corresponding recesses and projections.

As a functional element, for example, a cover could serve which could exclude the effects of the environment on the sample or samples. Thereby, dust protection would be realized. As a functional element, a heating plate could serve, for example, to form an incubation unit. The heating plate could comprise a temperature sensor to avoid overheating of the heating plate and/or the samples to be warmed and/or the sample holder. Alternatively or in addition thereto, the functional element could be formed by a cooling plate in order to exercise a predeterminable cooling effect on the sample or samples.

In an additional advantageous development of the sample holder the at least one functional element could be formed as a preferably frame-like attachment for supplying a gas or a gas mixture to at least one sample. Thereby, for example, a living sample could be provided with different gases or gas mixtures. This could, for example, be done during viewing under a microscope.

In a manner which is particularly simple from the standpoint of construction the attachment could comprise passages for the gas or gas mixture. Therewith, the gas or gas mixture could be conducted from outside through the passages to the sample. Alternatively or in addition thereto, the attachment could comprise passages for at least one tube through which the gas or gas mixture could be conducted from outside to the sample located in the sample holder.

To prepare a sample holder which could be handled quasi autonomously and without any connections, a gas cartridge or a gas container could be disposed on the attachment. A gas cartridge of this type or a gas container of this type could contain the gas or the gas mixture which is to be conducted to the sample. For example, the gas could be CO₂.

In a particularly advantageous development the attachment could be used in combination with a warming cover, a warming plate, or a heating plate.

In another advantageous development the at least one functional element could comprise an illumination device for at least one sample. Thereby, the effect of light on the sample can be investigated.

With regard to a particularly simple handling of the illumination device, the illumination device could be assigned to a preferably frame-like attachment. As an alternative, the illumination device could, in an also advantageous manner, be disposed on the inner side of a heating plate, a warming plate, a cooling plate, a warming cover, or a cover. Thereby, combined functional elements which exercise several functions can be realized.

In a development which is particularly simple from the standpoint of construction, the illumination device could comprise an LED, several LEDs, or one or more rows of LEDs. The expression “LED” denotes a light-emitting diode.

To ensure an individual, and in given cases also oblique, illumination, the illumination device, the one LED, the several LEDs, or the one or more rows of LEDs could be settable or adjustable with regard to their intensity and/or direction of illumination. Settability or adjustability of this type could preferably be independent of any other LEDs or rows of LEDs.

Through the individual adjustability it is also possible to illuminate the sample or samples laterally or obliquely. This offers the possibility of also generating “bright-field/dark-field” exposures in a closed sample chamber.

The at least one sample could be formed by a cover slip, an object holder, a chamber slide, a chamber cover slip, or an object holder with chambers, where the last named elements can serve for receiving a substance to be examined.

With the sample holder according to the invention it is possible to handle several samples simultaneously. Furthermore, the sample holder according to the invention can be handled by means of a robot. Through the sample holder according to the invention a modular assembly of a sample holder is ensured.

The sample holder according to the invention could be set into a predeterminable recess of a microscope table. Here a precise positioning of the sample holder relative to the microscope could take place. To that extent the sample holder could be designated as an “inlay”.

With the above-described fixing element it is possible to reduce positioning precision of samples disposed in the base frame or on the adapter based on their manufacturing precisions. In particular for samples which consist of a combination of a cover slip and a chamber slide, roughness occurs in their gluing, said roughness being substantially compensated by the fixing by means of the fixing element.

The initial objective is on the other hand also realized by a microscope assembly with a sample holder as described above. For this case, to avoid repetition of specifications and advantages of the particular development of the microscope assembly, reference is made at this point to the corresponding passages of the above description of the development of the sample holder according to the invention.

There are different possibilities of developing and extending the teaching of the present invention in an advantageous manner. For this, we refer to the following explanation of a preferred embodiment of the invention with the aid of the drawings. In connection with the explanation of the preferred embodiment of the invention with the aid of the drawings, generally preferred developments and extensions of the teaching are also explained.

### BRIEF DESCRIPTION OF THE DRAWINGS

Shown in the drawings are:

FIG. 1 is a perspective side view of an embodiment of the sample holder according to the invention,

FIG. 2 is a perspective side view of a fixing element for pressing a sample onto the base frame of the sample holder,

FIG. 3 is a perspective side view the sample holder of FIG. 1 with a fixing element disposed on its base frame,

FIG. 4 is an exploded side view the sample holder of FIG. 1 with functional elements, and

FIG. 5 is a schematic side view and a view from below the warming plate from FIG. 4, with an additional lighting device.

### DETAILED DESCRIPTION OF THE PREFERRED EMBODIMENTS

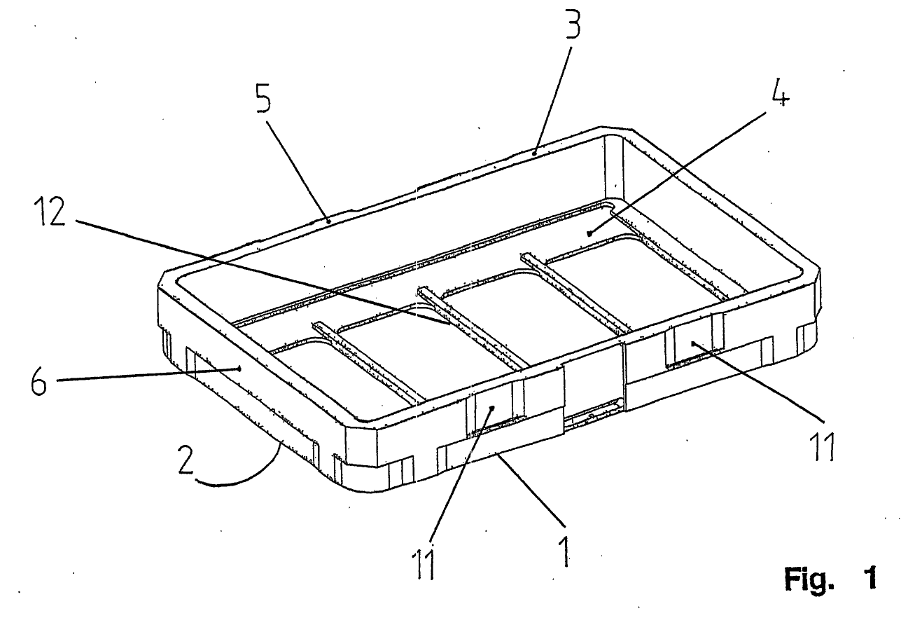

FIG. 1 shows an embodiment of a sample holder according to the invention in a perspective side view. The sample holder comprises a base frame 1 which in turn comprises an underside 2, an upper surface 3, and a receiving area 4 for samples. The receiving area 4 is divided into four subsections by means of three bars. In regard to a high sample throughput with means which are simple from the standpoint of construction, the base frame 1 comprises on its upper surface 3 a coupling area 5 for at least one additional functional element. A functional element of this type could, for example, be formed by a cover, a heating plate, or a cooling plate.

The base frame 1 comprises side walls 6 connected to one another, where the coupling area 5 is formed on the upper ends of the side walls 6.

The base frame 1 comprises a roughened grip area 11 for a more secure hold with, for example, an automated needle gripper. To limit heat transfer, the base frame 1 comprises additional passages 12 in its base.

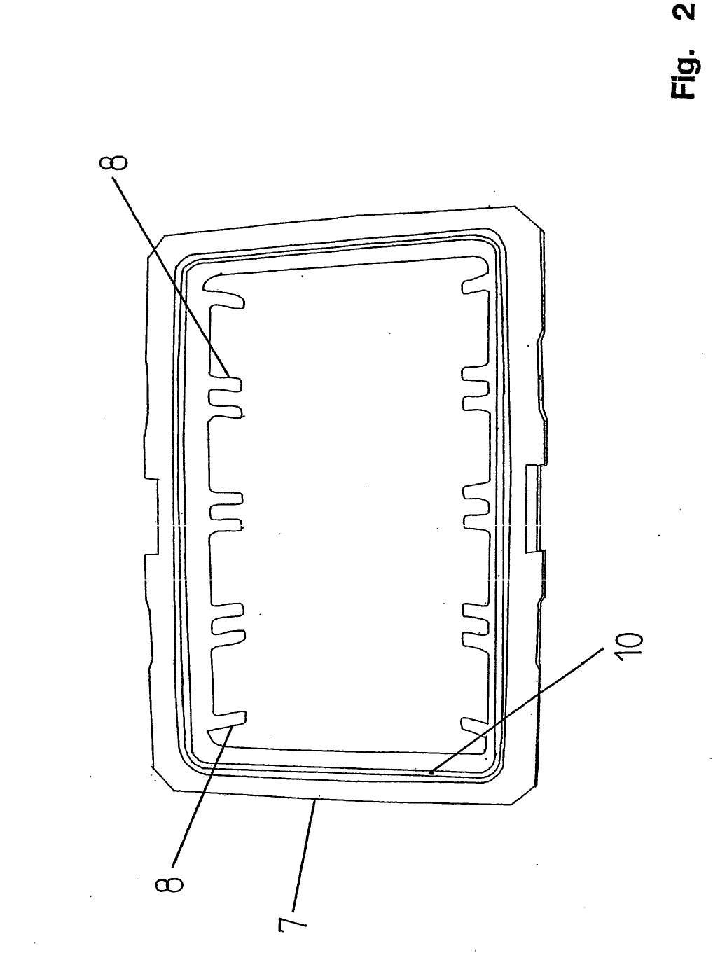

FIG. 2 shows in a perspective side view a frame-like fixing element 7, with which samples can be pressed against the base frame 1 or against an adapter set in the base frame 1. The fixing element 7 comprises springs 8 for pressing against the sample. The fixing element 7 comprises a coupling area 10 for at least one additional functional element in the form of, for example, a cover, a heating plate, or a cooling plate. The coupling area 10 is essentially formed by a recess or groove running along the upper edge of the fixing element 7. The fixing element 7 is fitted to the base frame 1 in such a manner that essentially no relative motion between the fixed element 7 and the base frame 1 in the horizontal direction is possible when the fixing element 7 is mounted on the base frame 1.

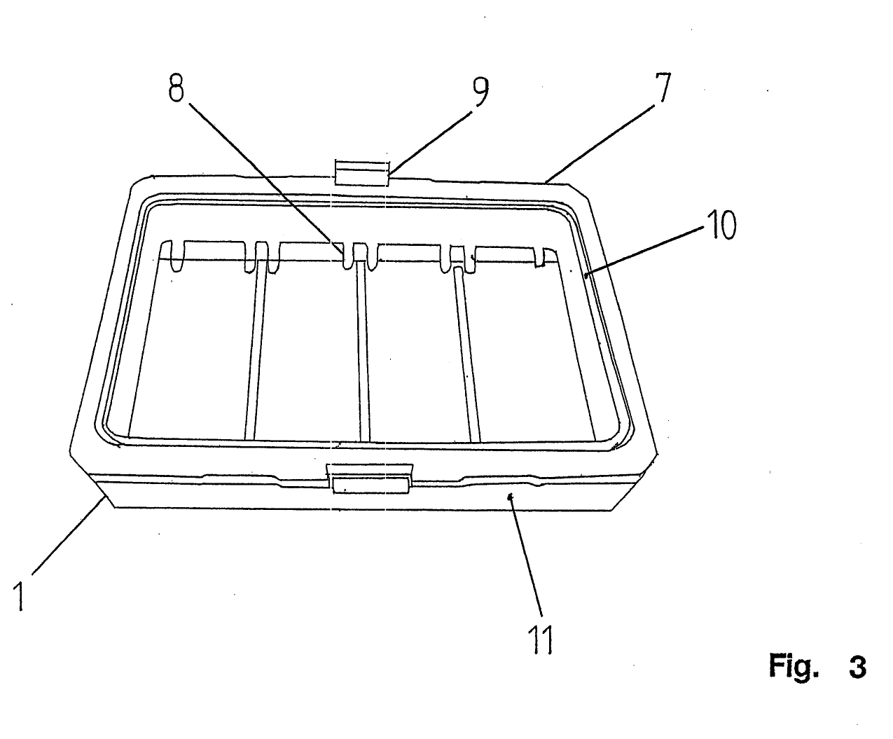

FIG. 3 shows the sample holder with the base frame 1 and the fixing element 7 mounted on the base frame 1. Samples in the form of chamber slides can be set in the base frame 1. For fastening the fixing element 7 onto the base frame 1, the base frame 1 comprises two clips 9, which engage over the fixing element 7.

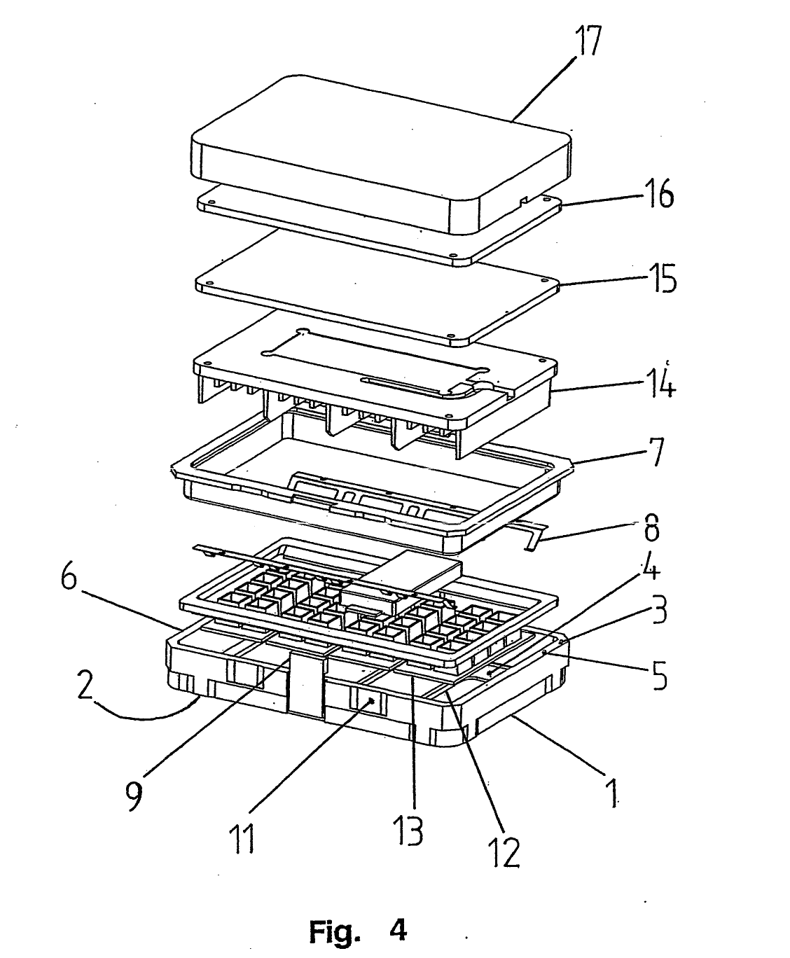

FIG. 4 shows in an exploded side view an assembly consisting of a sample holder with a base frame 1, where the sample holder supports an adapter in the form of an object holder 13 with chambers. As a functional element a warming plate 14 or heating plate is provided on which a cover plate 15, insulation 16, and an insulating hood 17 are disposed. Thereby, a thermally stable sample holder is realized.

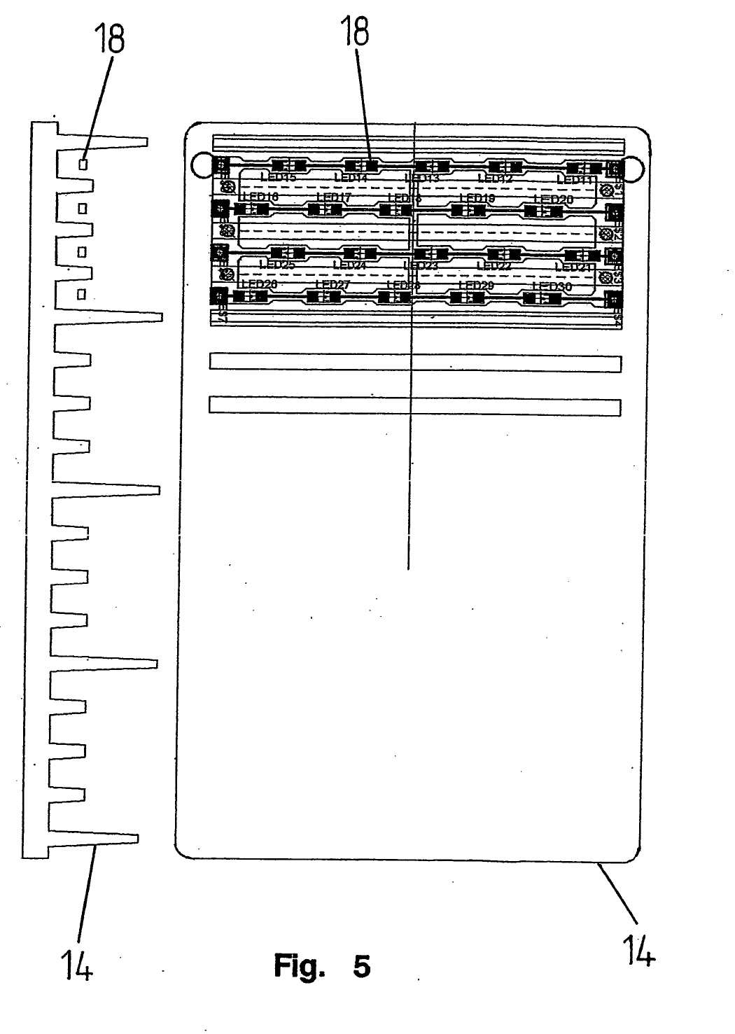

FIG. 5 shows in a side view and in a view from below, partially, the warming plate 14 shown in FIG. 4. In this case the warming plate 14 comprises an illuminating device which consists of several rows of LEDs 18. The illumination device is disposed on the underside of the warming plate 14.

To avoid repetition, with regard to further advantageous developments and extensions of the teaching according to the invention the reader is referred, on the one hand, to the general part of the description and, on the other hand, to the accompanying claims.

In conclusion, let it be emphasized quite particularly that the embodiment chosen in advance in a completely arbitrary manner serves only for the discussion of the teaching according to the invention but does not restrict it to this embodiment.

1. A sample holder which is adapted for handling samples to be viewed under a microscope, comprising a base frame which includes an underside, an upper surface, and at least one receiving area for at least one sample, and wherein the base frame further includes on its upper surface a coupling area for coupling at least one functional element to the base frame.

2. The sample holder according to claim 1, wherein the base frame further includes side walls connected to one another.

3. The sample holder according to claim 1, further comprising an adapter which comprises a plurality of individual receiving areas and which is disposed in the base frame.

4. The sample holder according to claim 3, further comprising a frame-like fixing element for the sample or samples mounted on or in the base frame.

5. The sample holder according to claim 4, wherein the fixing element comprises at least one spring for pressing the sample or samples onto the base frame or onto the adapter.

6. The sample holder according to claim 4, wherein the fixing element is configured to be latched or clamped on the base frame.

7. The sample holder according to claim 1, further comprising a frame-like fixing element for the sample or samples mounted on or in the base frame, with the fixing element joined to the base frame.

8. The sample holder according to claim 4, wherein the fixing element comprises a coupling area for coupling at least one additional functional element thereto.

9. The sample holder according to claim 1, wherein the base frame comprises at least one roughened grip area.

10. The sample holder according to claim 1, wherein the base frame comprises recesses and/or passages for controlling heat transfer.

11. The sample holder according to claim 7, wherein the base frame and/or the fixing element comprise a material which can be autoclaved.

12. The sample holder according to claim 7, wherein the base frame and/or the fixing element are configured to permit stacking.

13. The sample holder according to claim 1, wherein the at least one functional element is a cover, or a heating plate to form an incubation unit, or a cooling plate.

14. The sample holder according to claim 1, wherein the at least one functional element is formed as a frame-like attachment for supplying a gas or gas mixture to at least one sample.

15. The sample holder according to claim 14, wherein the attachment comprises passages for the gas or a gas mixture or for at least one tube.

16. The sample holder according to claim 14, wherein a gas cartridge or a gas container is disposed on the attachment.

17. The sample holder according to claim 16, wherein the gas is CO₂.

18. The sample holder according to claim 1, wherein the at least one functional element comprises an illumination device for at least one sample.

19. The sample holder according to claim 18, wherein the illumination device is assigned to a frame-like fixture.

20. The sample holder according to claim 18, wherein the illumination device is disposed on the inner side of a heating plate, or a warming plate, or a cooling plate, or a warming cover, or a cover.

21. The sample holder according to claim 18, wherein the illumination device comprises at least one LED, or one or more rows of LEDs.

22. The sample holder according to claim 18, wherein the illumination device comprises a plurality of LEDs which are set or adjusted with regard to their intensity and/or direction of illumination, independently of one another.

23. A microscope assembly which comprises a microscope and a sample holder which is adapted for handling samples to be viewed under the microscope, said sample holder comprising a base frame which includes an underside, an upper surface, and at least one receiving area for at least one sample, and wherein the base frame further includes on its upper surface a coupling area for coupling at least one functional element to the base frame.
